(19) United States
(12) Patent Application Publication
(10) Pub. No.: US 2006/0006707 A1
(43) Pub. Date: Jan. 12, 2006

(54) Seat post assembly for a bicycle

(76) Inventor: A. P. Lin, Changhwa City (TW)

Correspondence Address: CHARLES E. BAXLEY, ESQ., 90 JOHN STREET, THIRD FLOOR, NEW YORK, NY, 10038, US

(21) Appl. No.: 10/881,997

(22) Filed: Jun. 30, 2004

(51) Int. Cl. B62J 1/00

(52) U.S. Cl. 297/215.14

(57) ABSTRACT

A seat post assembly provided for position the seat with support beam, the seat post assembly is provided on the bottom thereof with two locking blocks and comprising: a post; a head mounted on top of the post and provided with two threaded positioning surfaces which having an axial hole; two clamp elements assembled to both sides of the head, each of the clamp elements provided with a threaded jointing surface which having a through hole, and a locking groove; a locking unit passing through the through hole of the clamp elements and the axial hole of the head for enabling the clamp elements to be locked with the head and positioning the locking blocks into the locking groove.

### BACKGROUND OF THE INVENTION

1. Field of the Invention

This invention relates to a seat post assembly, and more particularly to a seat post assembly for a bicycle that is not only provided for positioning the seat with support beam, but also facilitating the inclination-angle adjustment of the seat.

2. Description of the Prior Arts

As shown in FIG. 1, a conventional seat 1 for a bicycle must be additionally provided at the bottom surface with two metal support arms 2, and then it can be assembled on a seat post 3. The seat post 3 includes a rod portion 301 inserted in a seat tube of a bicycle, a lower mounting-base 302 mounted on top end of the rod portion 301 and an upper mounting-base 303. The opposite surfaces of lower and the upper mounting-base 302, 303 each formed with grooves corresponding to the support arms 2. The support arms 2 will be clamped and positioned in the grooves after the upper and the lower mounting-base 302 and 303 are locked with each other. Through this way, the seat 1 is indirectly mounted on the seat post 3.

Although the seat 1 can be mounted on the seat post 3 by means of the support arms 2, in real use, the support arms 2 are assembled on the seat 1 after the seat 1 is completely made. Thereby, not only the seat 1 will be increased in weight, but also the cost will be high and the assembly will also be inconvenient. Furthermore, it is not convenient for the user that the inclination angle of the seat 1 is impossible to be adjusted once the seat 1 is mounted on the seat post 3 through the support arms 2.

To overcome the above-mentioned disadvantages, someone invented another type seat with support beam. The support beam is integratedly formed on the bottom side of the seat by plastic ejection, which is not only capable of reducing the weight of the seat, but also can save the production cost, and no other extra assembly process is required. However, the problem is that the inclination angle for this type seat also cannot be adjusted.

The present invention has arisen to mitigate and/or obviate the afore-described disadvantages.

### SUMMARY OF THE INVENTION

The primary object of the present invention is to provide a seat post assembly for a bicycle that is not only provided for positioning the seat with support beam, but also facilitating the inclination-angle adjustment of the seat.

The seat post assembly in accordance with one aspect of the present invention is designed to position the seat with support beam. The support beam is integratedly formed on a bottom surface of the seat and extending in a longitudinal direction thereof, the support beam have a “ [symbol] ”-shaped cross section, on the bottom of the support beam longitudinally formed with two outward-protruded locking blocks, the seat post assembly comprises: a post; a head mounted on top of the post and laterally provided with two opposite threaded positioning surfaces, and an axial hole passing through the threaded positioning surfaces; two clamp elements assembled to both sides of the head and located in axial direction of the axial hole, each of the clamp elements provided with a threaded jointing surface corresponding to the threaded positioning surface, a through hole corresponding to the axial hole and passing through the threaded jointing surface, and a locking groove corresponding to one of the locking block; and a locking unit capable of passing through the through hole of the clamp elements and the axial hole of the head, enabling the clamp elements to be releasably locked with the head, and positioning the locking blocks of the support beam into the locking groove.

The present invention will become more obvious from the following description when taken in connection with the accompanying drawings, which show, for purpose of illustrations only, the preferred embodiments in accordance with the present invention.

### BRIEF DESCRIPTION OF THE DRAWINGS

FIG. 1 is an assembly perspective view of a conventional seat post assembly for a bicycle;

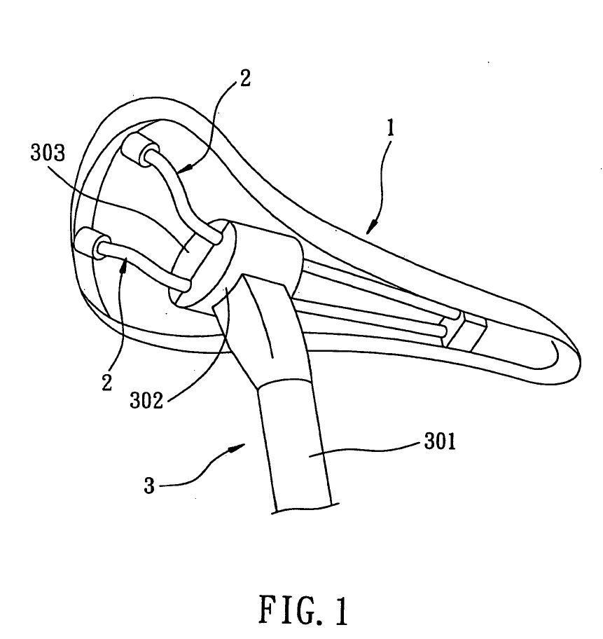

FIG. 2 is an exploded view of a seat post assembly and a seat for a bicycle in accordance with a first preferred embodiment of the present invention;

FIG. 3 is an assembly perspective view of a seat post assembly and a seat for a bicycle in accordance with the first preferred embodiment of the present invention;

FIG. 4 is an assembly cross sectional view of a seat post assembly and a seat for a bicycle in accordance with the first preferred embodiment of the present invention;

FIG. 5 is an operational view for showing the seat post assembly in accordance with the present invention is being adjusted the inclination angle;

FIG. 6 is an exploded view of a seat post assembly in accordance with a second preferred embodiment of the present invention.

### DETAILED DESCRIPTION OF THE PREFERRED EMBODIMENTS

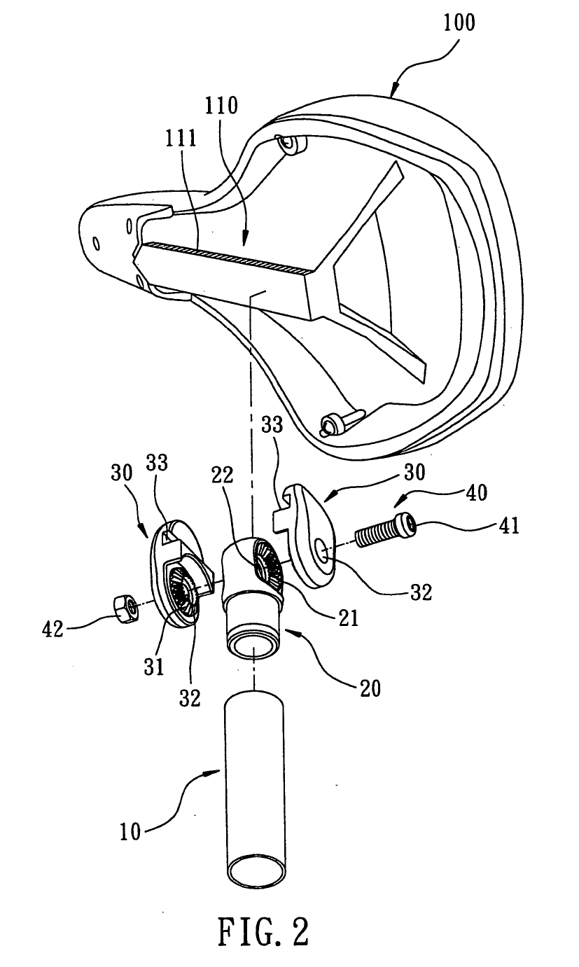

Referring to FIGS. 2-4, a seat post assembly for a bicycle in accordance with a first preferred embodiment of the present invention is provided for positioning a seat 100 with a support beam 110. The support beam 110 is integratedly formed on the bottom surface of the seat 100 by plastic ejection and located in the longitudinal direction of the seat 100. The support beam 110 has a “ [symbol] ”-shaped cross section, on the bottom of the support beam 110 is longitudinally formed with two locking blocks 111 which protrude outward. The seat post assembly includes: a post 10, a head 20, two clamp elements 30 and a locking unit 40.

The post 10, a lower end of which can be inserted in a seat tube on a frame of a bicycle (not shown).

The head 20 is inserted in top of the post 10 and laterally provided with two opposite threaded positioning surfaces 21 which are formed in the shape of concave cone, and an axial hole 22 passes through the threaded positioning surfaces 21.

The clamp elements 30 are assembled to both sides of the head 20 and located in axial direction of the axial hole 22. Each of the clamp elements 30 is provided with a convex-cone-shaped threaded jointing surface 31 which corresponds to the threaded positioning surface 21, a through hole 32 passing through the threaded jointing surface 31 which corresponds to the axial hole 22, and a locking groove 33 corresponds to the locking block 111.

The locking unit 40 includes a screw bolt 41 which can pass through the through holes 32 of the clamp elements 30 and the axial hole 22 of the head 20, and further includes a screw nut 42 can be screwed with the screw bolt 41.

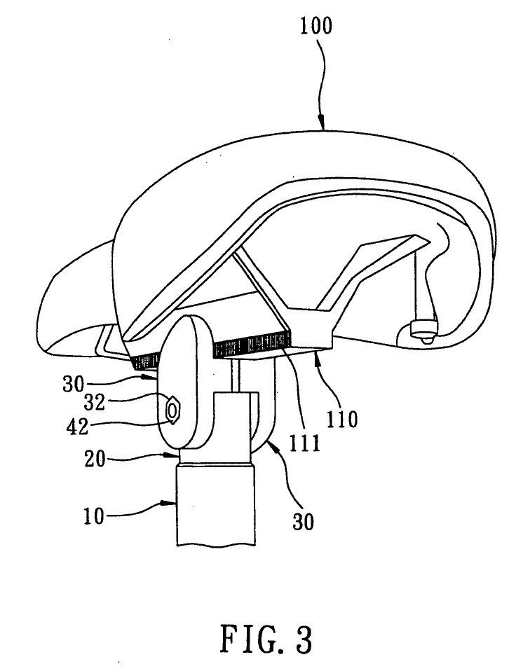

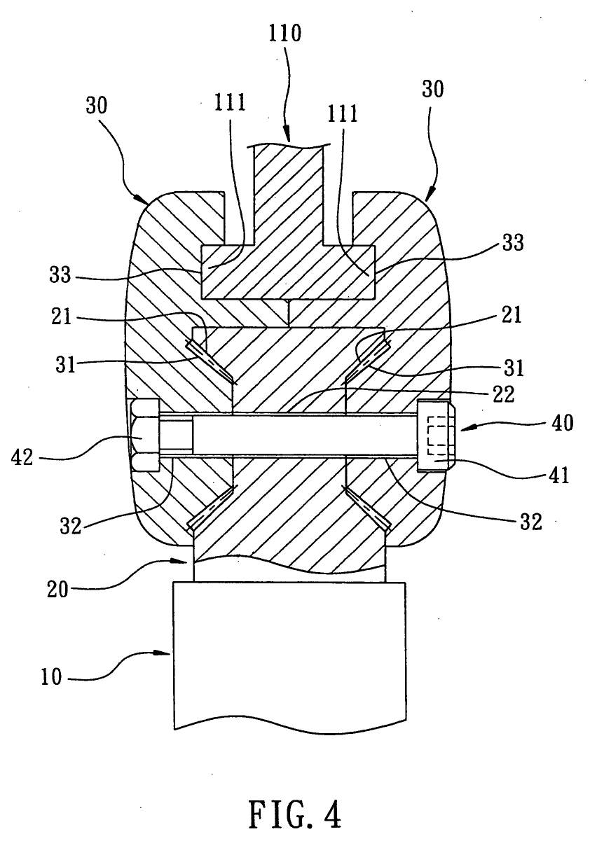

As shown in FIGS. 3 and 4, when the threaded jointing surfaces 31 of the clamp elements 30 are locked with the threaded positioning surfaces 21 of the head 20, the locking blocks 111 of the support beam 110 can be inserted in the locking groove 33, respectively. The screw bolt 41 can be screwed with the screw nut 42 after passing through the through holes 32 of the clamp elements 30 and the axial hole 22 of the head 20. After that, the clamp elements 30 are releasably locked with the head 20, so that the locking blocks 111 of the support beam 110 is positioned in the locking grooves 32. Through this way, the seat 100 is assembled on the seat post and then the seat post is inserted in a seat tube on the frame of the bicycle.

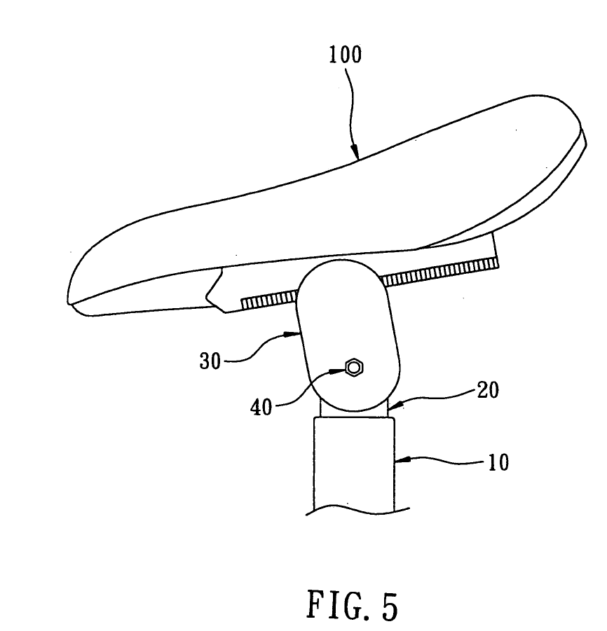

Referring to FIGS. 4 and 5, when wants to adjust the inclination angle of the seat 100, the user only needs to disengage the threaded jointing surfaces 31 of the clamp elements 30 from the threaded positioning surfaces 21 of the head 20 by loosening a little the locking unit 40. Then turning the clamp element 30, the seat 100 is driven to rotate relative to the head 20, so that the inclination angle of the seat 100 relative to the post 10 is changed. At this moment, the inclination angle of the seat 100 is fixed by tightening the locking unit 40.

Hence, the seat post assembly in accordance with the present invention has the advantages as follows:

The seat post assembly of the present invention is not only provided for positioning the seat 100 having support beam 110 so as to reduce the weight and save the production cost, but also facilitating inclination-adjustment of the seat 100 according to the user's needs.

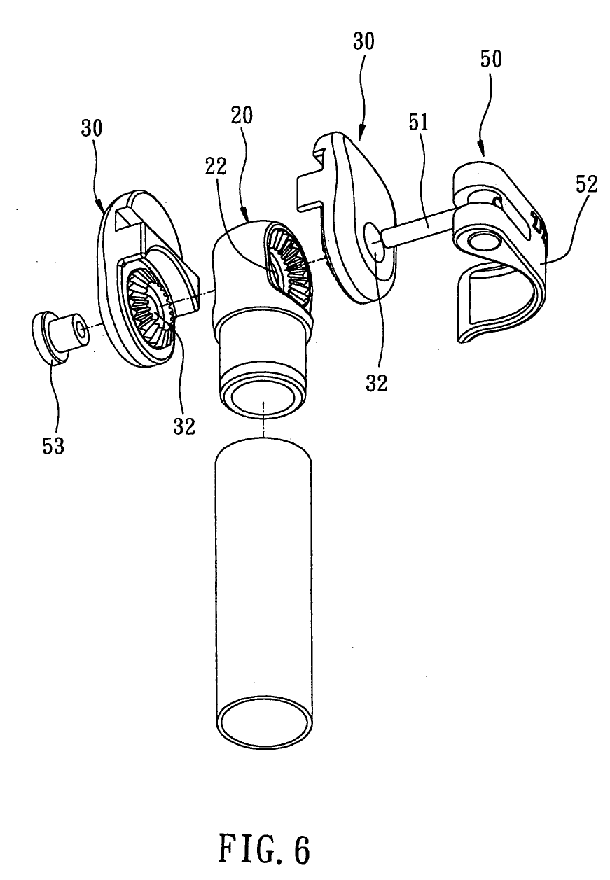

Referring to FIG. 6, a seat post assembly for a bicycle in accordance with a second embodiment of the present invention is shown, which is similar to that of the first embodiment. The only difference is that a locking unit 50 in the second embodiment is designed for quick assembly and disassembly. The locking unit 50 comprises a shaft 51 capable of inserting through the through holes 32 of the clamp elements 30 and the axial hole 22 of the head 20; a cam lever 52 which is pivotally connected to a first end of the shaft 51; and a quick-locking member 53 which is screwed with a second end of the shaft 51. The cam lever 52 is used to quick change the distance between the two clamp elements 30, so as to tighten or release the clamp elements 30. By this means, it also can achieve the same effect and function of the seat post assembly in the first embodiment.

While we have shown and described various embodiments in accordance with the present invention, it should be clear to those skilled in the art that further embodiments may be made without departing from the scope of the present invention.

What is claimed is:

1. A seat post assembly for a bicycle provided for positioning a seat with a support beam, the seat post assembly integratedly formed on a bottom surface of the seat and extending in a longitudinal direction thereof, the support beam having a “ [symbol] ”-shaped cross section, on the bottom of the support beam longitudinally formed with two outward-protruded locking blocks, the seat post assembly comprising:
a post;
a head mounted on top of the post and provided with two opposite threaded positioning surfaces, and an axial hole passing through the threaded positioning surfaces;
two clamp elements assembled to both sides of the inserting head and located in axial direction of the axial hole, each of the clamp elements provided with a threaded jointing surface corresponding to the threaded positioning surface, a through hole corresponding to the axial hole and passing through the threaded jointing surface, and a locking groove corresponding to one of the locking block; and
a locking unit capable of passing through the through hole of the clamp elements and the axial hole of the head for enabling the clamp elements to be releasably locked with the head and positioning the locking blocks of the support beam into the locking groove.

2. The seat post assembly for a bicycle as claimed in claim 1, wherein the threaded positioning surface of the head is formed in the shape of concave cone, and the threaded jointing surface of the clamp elements is formed in the shape of convex cone.

3. The seat post assembly for a bicycle as claimed in claim 1, wherein the locking unit includes a screw bolt capable of passing through the through hole of the clamp elements and the axial hole of the head, and further includes a screw nut employed to be screwed with the screw bolt.

4. The seat post assembly for a bicycle as claimed in claim 1, wherein the locking unit is allowed for quick assembly and disassembly and comprising a shaft for inserting through the through hole of the clamp elements and the axial hole of the head, a cam lever pivotally connected to a first end of the shaft, and a quick-locking member serves to be screwed with a second end of the shaft.
